(19) United States
(12) Patent Application Publication
(10) Pub. No.: US 2026/0139991 A1
(43) Pub. Date: May 21, 2026

(54) READOUT CIRCUITRY FOR PHOTON NUMBER DETECTORS

(71) Applicant: PsiQuantum Corp., Palo Alto, CA (US)

(72) Inventors: Avishai Benyamini, Palo Alto, CA (US); Nicholas C. Grabon, Palo Alto, CA (US); Gabriel A. Peterson, Mountain View, CA (US)

(21) Appl. No.: 19/450,143

(22) Filed: Jan. 15, 2026

Related U.S. Application Data
(63) Continuation of application No. PCT/US2024/039049, filed on Jul. 22, 2024.
(60) Provisional application No. 63/528,058, filed on Jul. 20, 2023.

(51) Int. Cl. G01J 1/44; G01J 1/04

(52) U.S. Cl. CPC G01J 1/44; G01J 1/0407; G01J 2001/4413

(57) ABSTRACT

The various embodiments described herein include methods, devices, and systems for detecting photons. In one aspect, a superconducting circuit includes an optical waveguide and a plurality of superconducting photon detectors optically coupled to the optical waveguide. The superconducting circuit further includes a readout circuit thermally coupled to the plurality of superconducting photon detectors, the readout circuit comprising respective readout components for the plurality of superconducting photon detectors, each respective readout component having a corresponding reset component.

### RELATED APPLICATIONS

This application is a continuation of PCT Patent Application No. PCT/US 2024/039049, filed Jul. 22, 2024, which claims priority to U.S. Provisional Patent Application 63/528,058, filed Jul. 20, 2023, each of which is hereby incorporated by reference in its entirety.

### TECHNICAL FIELD

The present application relates generally to readout circuits, including but not limited to, readout circuitry for photon number resolving detectors.

### BACKGROUND

Photon detectors are key components in many electronic devices. Ultra-sensitive photon detectors capable of detecting individual photons (e.g., single photons) can be used in a variety of applications, such as optical communications, medical diagnostics, space research, and optical quantum information computing. Ultra-sensitive photon detectors may utilize one or more superconductors. Superconductors are materials capable of operating in a superconducting state with zero electrical resistance under particular conditions. It is difficult for readout circuits to readout detection signaling and operate at a fast timescale that is congruent with photon detectors.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 illustrates an example photon detection circuit in accordance with some embodiments.

FIG. 2A illustrates an example detector unit cell in accordance with some embodiments.

FIG. 2B illustrates an example layout for the detector unit cell of FIG. 2A in accordance with some embodiments.

FIG. 3A illustrates an example photon detection circuit in accordance with some embodiments.

FIG. 3B illustrates an example layout for a portion of the photon detection circuit of FIG. 3A in accordance with some embodiments.

FIGS. 4A-4C are prophetic diagrams illustrating a representative operating sequence of the circuit of FIG. 3A in accordance with some embodiments.

FIGS. 5A-5B illustrate a representative photonic circuit employing a superconducting photon detector in accordance with one or more embodiments.

FIG. 6 shows a flow diagram of an example method for implementing fast readouts rates of photons using photon detectors, in accordance with one or more embodiments.

In accordance with common practice, the various features illustrated in the drawings are not necessarily drawn to scale, and like reference numerals can be used to denote like features throughout the specification and figures.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

As discussed above, it can be difficult to implement photon detectors to detect photons in a fast manner. One further difficulty includes detection of a quantity of photons (e.g., detecting 4 photons) propagating in a given optical guide (e.g., waveguide, fiber, free space). As discussed in more detail below, a photon number resolving detector (PNRD) can include multiple detection cells, each cell can detect one photon to output which number of unit cells were triggered, thereby indicating the number of photons that were detected by the PNRD. The readout component of a PNRD can be implemented as a superconducting element that is initially in a superconducting state, but upon being triggered by a incident photon, the superconducting element transitions to a non-superconducting state with high resistance. For a number of unit cells, each having reset elements, the overall resistance from each readout element creates a RC time constant with finite capacitance from a nearby readout line that can limit the rate at which the PNRD can function. To address the forgoing, a reset component can be implemented in parallel with the readout component in each unit cell of a photon detector, in accordance with some example embodiments. The reset component can have a lower resistance than the readout component such that upon a photon transitioning the readout component, the current can flow to the lower resistance reset component. In this way, the operational rate of the photon detector can be increased (e.g., the detection repetition rate can be increased). In some example embodiments, the collective resistance of each readout component from each cell contributes to a total resistance for a time constant (e.g., RC time constant) overall for the detector. As an example, the PNRD comprises four unit cells having four readout elements that transition to a non-superconducting state upon photon detection (e.g., a first photon incident on the first cell, the second photon incident on the second cell, and so on). If a triggered readout element has a 1 kOhm resistance, then collectively, the four readout elements have a 4k Ohm resistance. Further, if a readout line has a practical finite capacitance, such as 100 fF, the timescale is then 400 ps, where the overall relaxation or setting time would be approximately 3 ns, which limits the rate of operation of the photon detection system. As an illustrative example, and in accordance with some example embodiments, a reset component of 100 Ohms is implemented in parallel with each of the four reset components (each reset component in parallel with a single 100 ohm reset component), such that, collectively, the time scale for the device is reduced to 280 ps, with a corresponding reduction in setting time, in accordance with some example embodiments. In this way, readout rates for superconducting photon detectors can be efficiently increased and operate at higher rates.

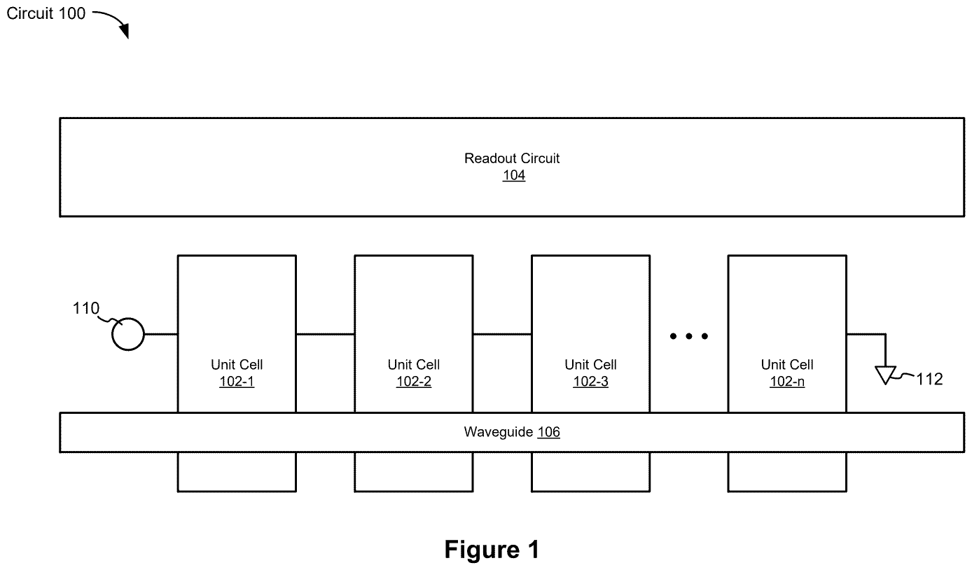

FIG. 1 illustrates a photon detection circuit 100 in accordance with some embodiments. The photon detection circuit 100 includes a waveguide 106, unit cells 102 (e.g., unit cell 102-1 through 102-n), and a readout circuit 104. The photon detection circuit 100 further includes an electrical source 110 and an electrical ground 112. For example, the waveguide 106 is an optical waveguide that is optically coupled to the unit cells 102. In some embodiments, the electrical source 110 is a current source, e.g., a direct current (DC) source. In some embodiments, the electrical source 110 is a voltage source. In some embodiments, the electrical source 110 is configured to supply a current to the unit cells 102 that biases the unit cells 102 in the superconducting state in the absence of any incident photons (e.g., photons from the waveguide 106). In operation, current from the electrical source 110 flows through the unit cells 102 to the electrical ground 112.

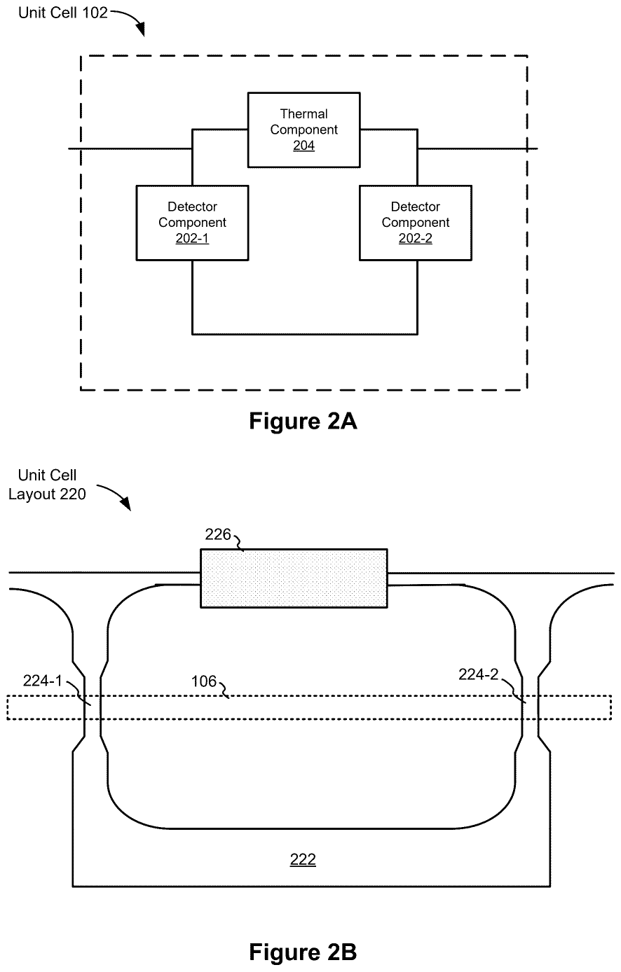

FIG. 2A illustrates a detector unit cell 102 in accordance with some embodiments. The detector unit cell 102 includes detector components 202 (e.g., detector components 202-1 and 202-2) and a thermal component 204. In some embodiments, the thermal component 204 is, or includes, a resistor. In some embodiments, the thermal component 204 is composed of a superconducting material and is shaped to transition from a superconducting state to a non-superconducting state in response to a change in state of the detector (e.g., receiving electrical current from current source 110, receiving current from detector components 202-1 and 202-2). In some embodiments, the thermal component 204 has a resistance in the range of 0.1 ohms to 1000 ohms (e.g., while in a non-superconducting state).

In some embodiments, the detector components 202 are superconducting nanowire single photon detectors (SNSPDs). For example, the detector component 202-1 is adapted, and biased, to operate in a superconducting state in the absence of any incident photons. In this example, in response to an incident photon (e.g., from the waveguide 106), the detector component 202-1 transitions from the superconducting state to a non-superconducting (e.g., resistive) state. In the superconducting state, the detector component 202-1 has zero resistance. In the non-superconducting state, the detector component 202-1 has a resistance of at least 1 kiloohm (e.g., 5 kiloohms or 10 kiloohms). After transitioning to the non-superconducting state, the detector component 202-1 requires a certain amount of time to transition back to the superconducting state, e.g., a reset time (T). In some embodiments, the superconducting component has an associated reset time in the range of 0.1 nanoseconds to 100 nanoseconds (e.g., 1 nanosecond).

In some embodiments, the detector unit cell 102 includes one or more inductors (e.g., inherent inductors). The inductor(s) delay current from rerouting within the detector unit cell 102. The unit cell 102 may have an associated reset time (T), where the reset time is an amount of time elapsed, beginning when a detector component 202 transitions to the non-superconducting state, until current returns to the detector component 202. In some embodiments, the inductor(s) have an inductance in the range of 50 nanohenries to 200 nanohenries (e.g., 100 nanohenries). As an example, the detector unit cell 102 may have a resistance of 50 ohms and an inductance of 100 nanohenries, resulting in an RL time constant of 2 nanoseconds (e.g., L/R=time constant, with L measured in Henries, R measured in Ohms, and the time constant expressed in units of seconds).

In some embodiments, the detector unit cell 102 has a kinetic inductance in the range of 50 nanohenries to 200 nanohenries (e.g., 100 nanohenries). As used herein, kinetic inductance is an inductance per square of material. In some embodiments, the detector unit cell 102 is composed of a superconducting material. In some embodiments, the superconducting material has a per square kinetic inductance in the range of 10 picohenries to 200 picohenries (e.g., 100 picohenries). In some embodiments, the superconducting material has a per square kinetic inductance of less than 1 nanohenry while in the superconducting state and a negligible per square kinetic inductance (e.g., less than 1 picohenry) while in the non-superconducting state. For example, detector unit cell 102 has a kinetic inductance of 100 nanohenries and is composed of 1000 squares of superconducting material, e.g., has a width of 200 nanometers and a length of 2000 microns.

FIG. 2B illustrates a layout 220 for the detector unit cell of FIG. 2A in accordance with some embodiments. The layout 220 is composed of a superconducting material 222 (e.g., Niobium Nitride (NbN), Niobium Titanium Nitride (NbTiN), Tungsten Silicide (WSi), Magnesium Diboride (MgB2) having narrow portions 224 that correspond to the detector components 202. For example, narrow portion 224-1 corresponds to the detector component 202-1 and narrow portion 224-2 corresponds to the detector component 202-2. The waveguide 106 is shown in FIG. 2B overlapping with the narrow portions 224. In accordance with some embodiments, photons traveling within the waveguide 106 transfer to one of the narrow portions 224 (e.g., become incident photons to one of the detector components 202).

The layout 220 further includes a resistive region 226 (e.g., corresponding to the thermal component 204 in FIG. 2A). The resistive region 226 in the layout 220 may be composed of a conductive material that is, or includes, a metal (e.g., copper (Cu), aluminum (Al), tungsten (W), and/or gold (Au)). In some embodiments, the resistive region 204 has a length and/or width in the range of 5 nanometers to 5000 nanometers. The resistive region 226 is shown as rectangular in FIG. 2B, however, in other embodiments, the resistive region 226 has a non-rectangular shape (e.g., has rounded corners or a different geometric shape). In some embodiments, the resistive region 226 is configured to have a resistance in the range of 0.1 ohms to 500 ohms. In some embodiments, the resistive region 226 has resistance due contact resistance between different materials (e.g., resistance due to a superconductor to metal interface).

When the detector unit cell is operated at temperatures below a critical temperature for the superconducting components and is biased by a biasing current for photon detection, photons that transfer to a respective narrow portion 224 (e.g., a photon is absorbed by the narrow portion 224) cause the respective narrow portion to transition from the superconducting state to the non-superconducting state. As an example operating sequence, at a first time the narrow portions 224 are in the superconducting state and have zero resistance. Therefore, at the first time, all (or a majority of) current from a current source (e.g., the electrical source 110) flows through the narrow portions 224 to an electrical ground (e.g., the electrical ground 112). To continue the example operating sequence, at a second time, one (or both) of the narrow portions 224 is in a non-superconducting state, e.g., due to an incident photon from the waveguide 106. Therefore, at the second time, a majority of the current from the current source flows through the resistive region 226 to the electrical ground.

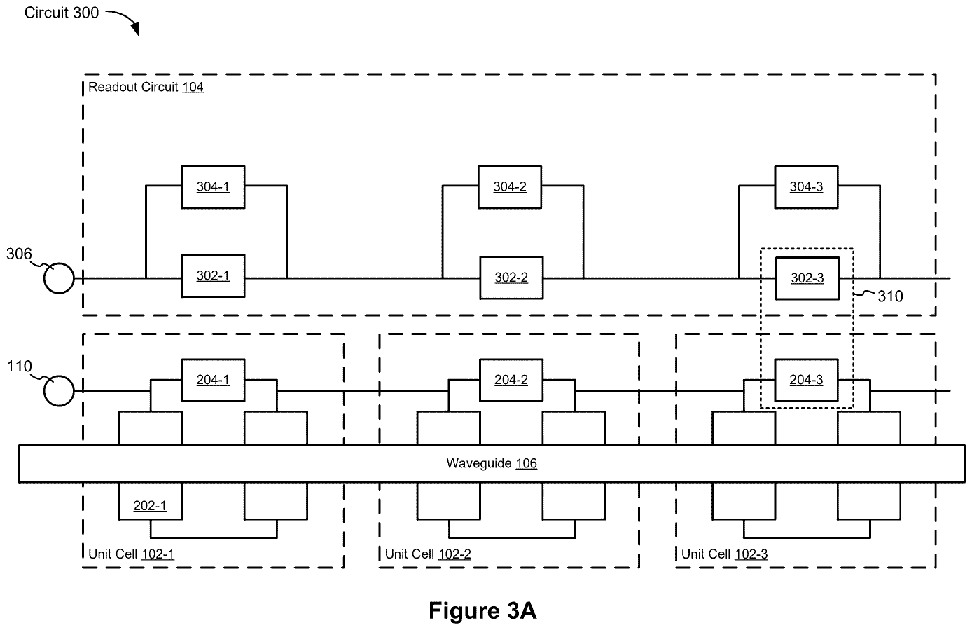

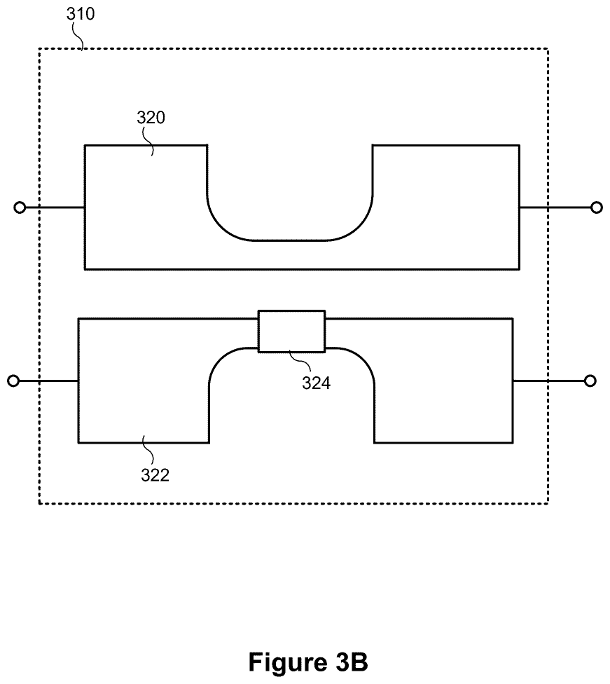

FIG. 3A illustrates a photon detection circuit 300 in accordance with some embodiments. The photon detection circuit 300 includes the readout circuit 104, the waveguide 106, and the unit cells 102. The photon detection circuit 300 also includes the electrical source 110 and an electrical source 306 (e.g., a current source). FIG. 3A also shows a dotted-line box indicating a portion 310 that includes the thermal component 204-3 and the readout component 302-3. The unit cells 102 in FIG. 3A (e.g., the unit cells 102-1, 102-2, 102-3, and 102-n) each include the thermal component 204 and the detector components 202 described above with respect to FIG. 2A. The readout circuit 104 in FIG. 3A includes readout components 302 and reset components 304. Each readout component 302 is arranged adjacent to (in proximity to) a corresponding thermal component 204 (e.g., the readout component 302-1 is adjacent to the thermal component 204-1). In some embodiments, the readout component 302-1 is thermally coupled to, and electrically insulated from, the thermal component 204-1.

In some embodiments, the readout components 302 are composed of superconducting material. In some embodiments, each reset component 304 is, or includes, a resistive element. In some embodiments, the reset component 304 is sized (and/or otherwise adapted) to have a resistance that is at least 3 times smaller than a resistance of a corresponding readout component 302 (e.g., while the readout component 302 is in a non-superconducting state). For example, a readout component 302 may have a resistance in the range of 1 kiloohm to 10 kiloohms while in a non-superconducting state and a corresponding reset component may have a resistance in the range of 50 ohms to 500 ohms. In some example embodiments, current is transferred to a given superconducting component using metal contacts (e.g., metal contacts to connect a superconducting element to electrical source 306, ground, or next component). While superconducting elements can have zero conductivity, in accordance with some example embodiments, resistance of given superconducting element can be varied by varying the contact area between the superconducting element and its metal contacts. In some example embodiments, by widening the metal respective contact areas of a given superconducting element, the resistivity of the superconducting element decreases; while narrowing the contact areas of the respective contact areas of a given superconducting element increases the resistivity of the superconducting element. For example, the metal contacts of readout component 302-1 are narrower than the metal contacts of reset component 304-1 such that the resistivity of the reset component is smaller (e.g., three or more times smaller than the resistivity of the readout component 302-1). In some example embodiments, the readout components 302 and the reset components 304 are formed in the same layer (e.g., a single layer of superconducting material) and/or in the same manufacturing process (e.g., forming a given layer, deposition, etching). In some example embodiments, the readout components 302 and the reset components 304 are formed from the same superconducting material. Example materials include: Niobium Nitride (NbN), Niobium Titanium Nitride (NbTiN), Tungsten Silicide (WSi), Magnesium Diboride (MgB2)), in accordance with some example embodiments. In some example embodiments, the resistivity of the elements can be varied using other approaches, by implementing different impurities in the readout components 302 and reset components 304, or using different superconducting materials for the readout components 302 and reset components 304.

FIG. 3B illustrates an example layout for the portion 310 of the photon detection circuit of FIG. 3A in accordance with some embodiments. FIG. 3B shows a superconducting region 322 with a resistive region 324. In some embodiments, the resistive region 324 has a resistance in the range of 5 ohms to 1000 ohms. The superconducting region 322 with the resistive region 324 corresponds to a thermal component 204. FIG. 3B further shows a superconducting region 320 that corresponds to a readout component 302. The resistive region 324 generates heat in response to receiving electrical current. In some embodiments, the heat generated by the resistive region 324 is insufficient to cause the superconducting region 320 to transition from a superconducting state to a non-superconducting state. The superconducting region 322 generates heat while receiving electrical current in a non-superconducting state. In some embodiments, the combined heat from the resistive region 324 and the superconducting region 322 is sufficient to cause the superconducting region 320 to transition from the superconducting state to the non-superconducting state. FIG. 3B shows the superconducting region 320 and the superconducting region 322 each having a constricted region in proximity to one another. In other embodiments, the superconducting region 320 and/or the superconducting region 322 has a different shape (e.g., a different curvature and/or different dimensions). In some embodiments, a coupling component is positioned between the superconducting region 320 and the superconducting region 322. In some embodiments, the coupling component is composed of a thermally-conductive, electrically-insulating material. In some embodiments, the coupling component is composed of a dielectric material. In some embodiments, the coupling component has a length sufficient to inhibit tunneling effects between the superconducting region 320 and the superconducting region 322 and/or short enough so as to be less than a photon's mean free path (e.g., in the range of 5 nm to 1 micron).

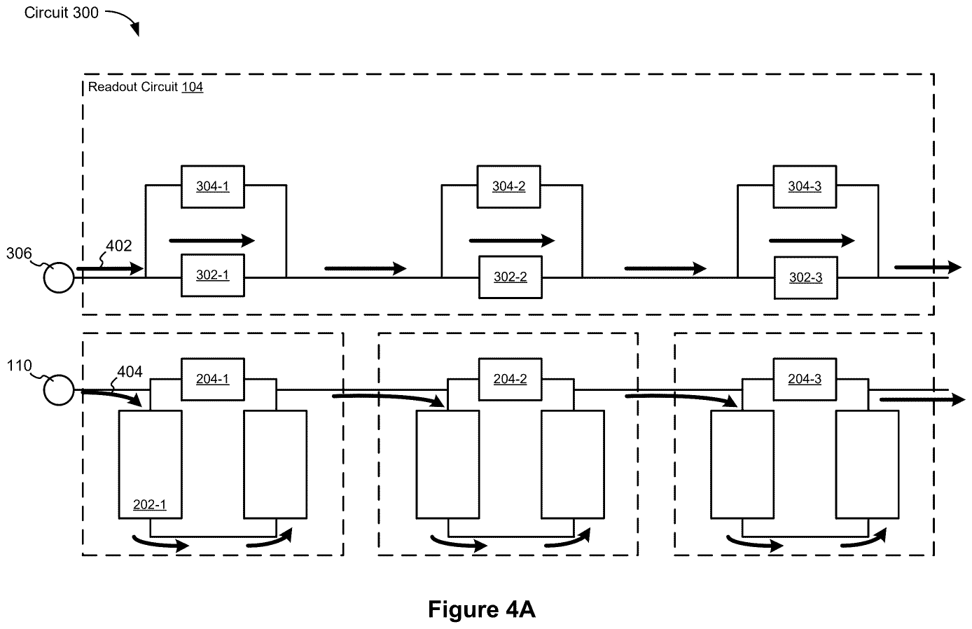

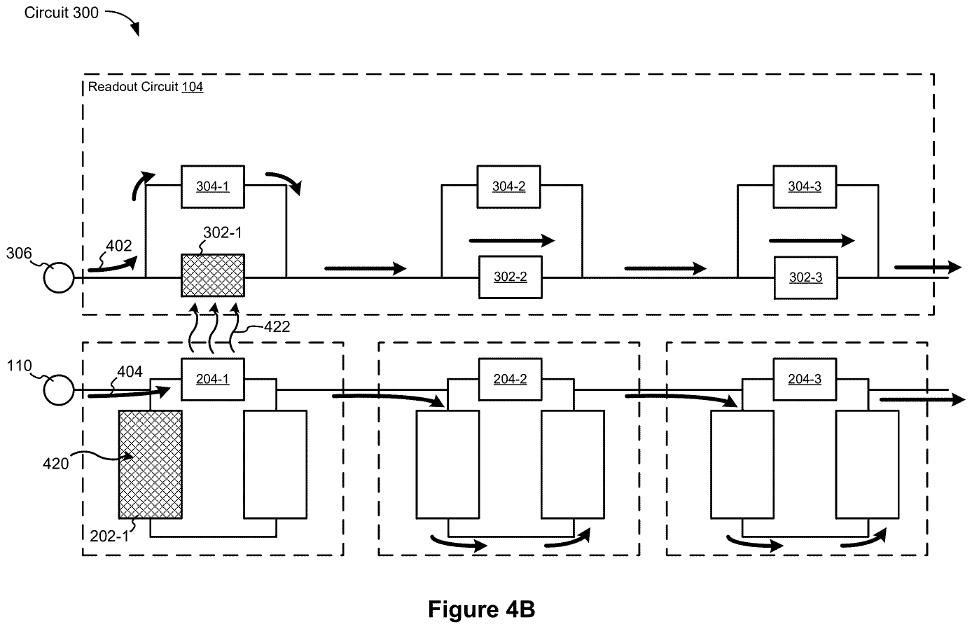

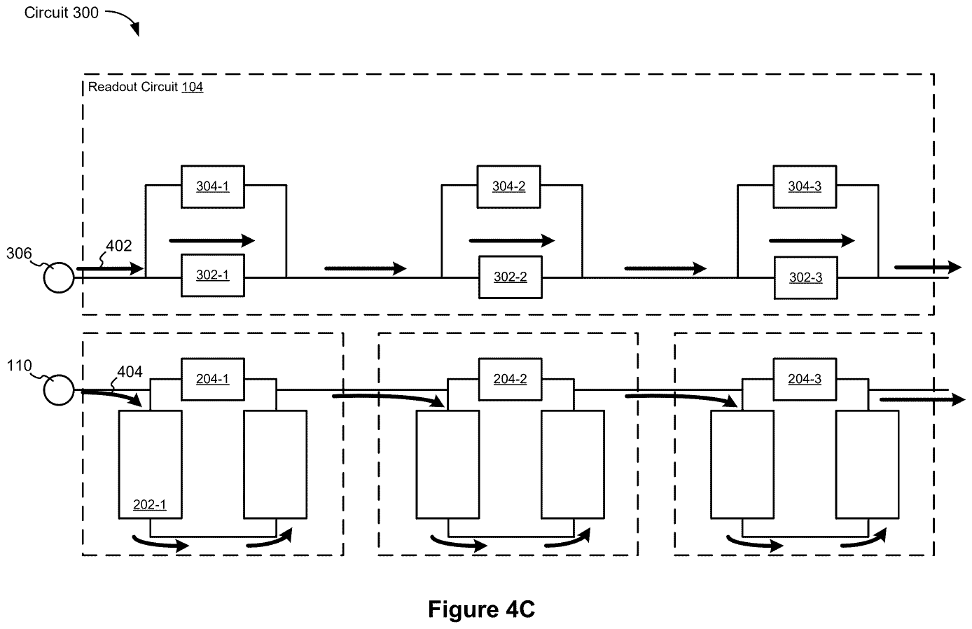

FIGS. 4A-4C are diagrams illustrating a representative operating sequence of the circuit of FIG. 3A in accordance with some embodiments. FIG. 4A shows the circuit 300 at a first time. At the first time, current 402 from the electrical source 306 flows through the readout components 302-1, 302-2, and 302-3; and current 404 from the electrical source 110 flows through the detector components 202. In some embodiments, at the first time, the detector components 202 and the readout components 302 are in the superconducting state. In some example embodiments in which the reset component 304 and the thermal component 204 are resistive, at the first time, negligible current flows through the reset components 304; and negligible current flows through the thermal components 204. In some example embodiments, in which the reset component 304 and the thermal component 204 are superconducting, at the first time, current flows through the 304 and the 204.

FIG. 4B shows the circuit 300 at a second time, subsequent to the first time. At the second time, a photon 420 is incident at the detector component 202-1. For example, the photon 420 is received from the waveguide 106. The photon 420 causes the detector component 202-1 to transition from the superconducting state to a non-superconducting state. In the non-superconducting state, the detector component 202-1 has resistance (e.g., in the range of 1 kiloohm to 50 kiloohms). Due to the resistance of the detector component 202-1, a portion of the current 404 (e.g., a majority of the current 404) flows through the thermal component 204-1. The portion of the current 404 flowing through the thermal component 204-1 causes the thermal component 204-1 to generate heat 422. The heat 422 causes the readout component 302-1 to transition from the superconducting state to the non-superconducting state. In the non-superconducting state, the readout component 302-1 has resistance (e.g., in the range of 1 kiloohm to 50 kiloohms). Due to the resistance of the readout component 302-1, a portion of the current 402 (e.g., a majority of the current 402) flows through the reset component 304-1. For example, the reset component 304-1 has a resistance in the range of 10 ohms to 500 ohms. In some embodiments, the readout circuit 104 includes a current measurement component configured to measure an amount of the current 402 in the reset components 304 (e.g., count a number of readout components in the non-superconducting state). In some embodiments, the readout circuit 104 includes a voltage measurement component to measure the voltage of the current flowing through the reset components 304 (e.g., determine a number of readout components in the non-superconducting state based on a voltage value).

FIG. 4C shows the circuit 300 at a third time, subsequent to the second time (e.g., 1-2 nanoseconds after the second time). At the third time, the detector component 202-1 and the readout component 302-1 have transitioned from the non-superconducting state to the superconducting state (e.g., have reset). Due to the detector component 202-1 being in the superconducting state, the current 404 flows through the detector component 202-1 at the third time. Due to the readout component 302-1 being in the superconducting state, the current 402 flows through the readout component 302-1 at the third time. In this way, the reset time can be lowered (e.g., by implementing reset components) such that the circuit 300 is ready to perform additional detections. Further, the lowering of the reset time in turns increases the repetition rate of the device such that the readout device can operate at high speeds that are congruent with the fast operation times of the detection components.

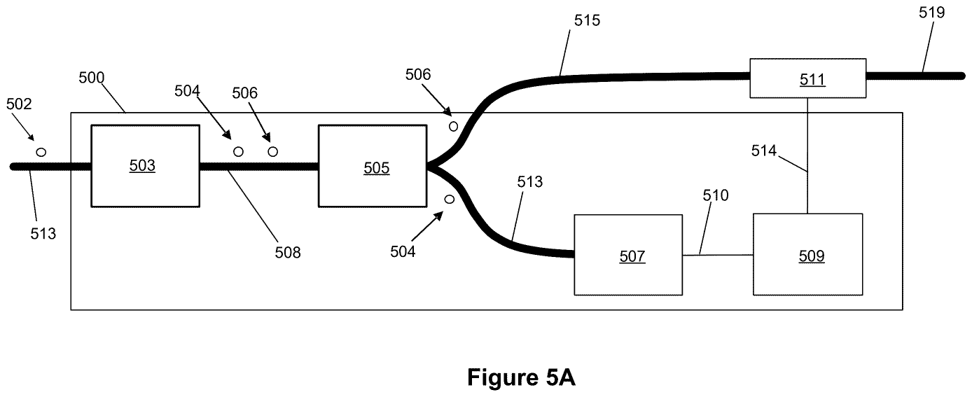

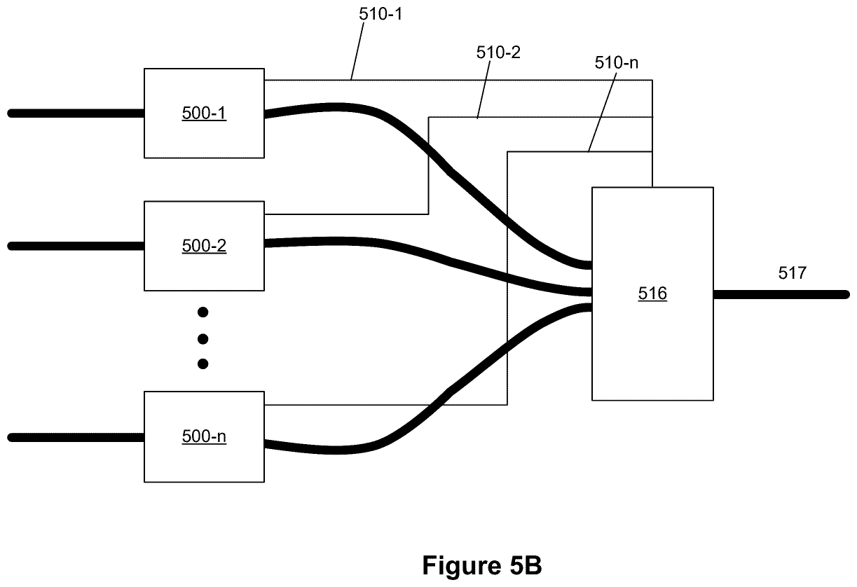

FIGS. 5A-5B show examples of a photonic system that can employ one or more superconducting circuits described herein in accordance with one or more embodiments. In the embodiments shown in FIGS. 5A-5B, a superconducting circuit, e.g., the circuits 100 and/or 300 and/or any of the arrangements shown in FIGS. 1-4C described above can be employed as one or more components, e.g., as readout circuits for photodetectors such as single-photon detectors. More specifically, the FIGS. 5A-5B illustrate a heralded single photon source in accordance with one or more embodiments. Such a source can be used within any system for which a source of single photons is useful, e.g., within a quantum communications system and/or a quantum computer that employs entangled photons as the physical qubits.

Turning to FIG. 5A, a heralded single photon source 500 is illustrated in accordance with one or more embodiments. Thick black lines in the figure represent optical waveguides and thin black lines represent electrical interconnects (e.g., wires that may be formed from superconducting or non-superconducting materials). The system is a hybrid photonic/electrical circuit that includes a pumped photon pair generator 503, a wavelength division multiplexer (WDM) 505 (which is a 1×2 WDM in this example), a superconducting photon detector 507, a superconducting amplifier circuit 509, and an optical switch 511. One or more components of the system can be housed in a cryogenic environment, such as a cryostat, held at a temperature that is lower than the threshold temperature for superconductivity, as described above.

An input optical waveguide 513 optically couples a pump photon source (not shown) to photon pair generator 503. A pump photon 502 enters the pumped photon pair generator 503 via input optical waveguide 513. For the sake of illustration, any photons illustrated here are depicted outside of the waveguides, but one of ordinary skill will appreciate that in a physical device, these photons will propagate within one or more guided modes of the waveguide. In some embodiments, the pumped photon pair generator 503 can include a nonlinear optical material that generates two output photons, referred to as signal photon 504 and idler photon 506 from one or more input pump photons 502. For example, the pumped photon pair generator 503 can generate a pair of output photons using a process known as spontaneous four wave mixing. The pair of output photons, signal photon 504 and idler photon 506, are typically generated having different wavelengths/frequencies, e.g., with the sum of the energies of the signal and idler equal to the energy of the pump photon. After generation, signal photon 504 and idler photon 506 are optically coupled to the input of WDM 505 via waveguide 508. Because photons 504 and 506 have different wavelengths/frequencies, WDM 505 redirects each photon along a different output waveguide, e.g., signal photon 504 is directed along the heralding waveguide path 513 and idler photon 506 is redirected along the switched output waveguide path 515. Which photon is directed to which path is not critical and the path of the idler photon and signal photon can be exchanged without departing from the scope of the present disclosure.

In this example, a superconducting photon detector 507, e.g., a superconducting nanowire single photon detector, is optically coupled to the heralding waveguide path 513 and can produce an electrical signal (e.g., a current pulse, also referred to as a photon heralding signal) in response to the detection of the signal photon 504. Because the signal photon 504 and idler photon 506 were generated nearly simultaneously as a pair, the electrical signal generated by the photon detector 507 signals (e.g., “heralds”) the presence of the idler photon 506 in the switched output waveguide path 515. The heralding signal is often a small amplitude current signal, e.g., microamps or less, and can be provided to the superconducting amplifier circuit 509 where it is amplified to a larger output signal 514 that can be used to more effectively drive any downstream electronic and/or photonic circuits. Accordingly, the use of the superconducting amplifier circuit 509 provides for a system that can drive higher current loads than would be the case with photon detector 507 operating on its own. After being switched, the idler photon 506 is provided via output waveguide 519, e.g., for use in constructing a highly entangled resource state for use in a downstream optical quantum computing system (not shown). In some embodiments, a unit cell 102 described previously is used as the photon detector 507. In some embodiments, the readout circuit 104 described previously is used as the superconducting amplifier circuit 509. In some embodiments, the circuit 100 or 300 is used as a logic component (e.g., downstream of the optical switch 511).

FIG. 5B illustrates how several single photon sources similar to photon source 500 can be multiplexed to increase the reliability of the photon generation process. Such a system is beneficial because of the non-deterministic nature of the conversion between the pump photon and the photon pair in the photon pair generator 503. More specifically, because the photon pair generation process is a quantum mechanical process, it is inherently probabilistic, and thus it is not guaranteed that every pump photon that enters a photon pair generator 503 will result in the generation of a photon pair at the output. In fact, in some instances, the photon pair creation can fail entirely. Thus, to improve the reliability of the photon generation process, several single photon generators 500-1, 500-2, . . . , 500-n, each receiving its own pump photon per generation cycle, can be arranged in parallel and optically (and electrically) coupled to a Nx1 switch 516, as shown. As with the heralded single photon source 500, each single photon generator 500-1, 500-2, . . . , 500-n possesses, or has an output coupled to, a corresponding dedicated heralding electrical signal line 510-1, 510-2, . . . , 510-n, which can provide a heralding signal that informs a downstream circuit element of the successful generation of a photon by that particular photon source. In some embodiments, the heralding electrical signal lines 510-1, 510-2, . . . , 510-n are electrically coupled to the Nx1 switch 516. Nx1 switch 516 includes digital logic that interprets the heralding electrical signals and switches the input port of the Nx1 switch 516 accordingly so as to provide the generated idler photon to the output port 517. Thus, in this case, each photon source 500 includes a superconducting amplifier circuit whose internal arrangement of current sources and parallel superconducting wires provides for enough amplification to drive the logic stage of the Nx1 switch. In other examples, a small signal logic circuit can be employed before the amplifier and Nx1 switch. One of ordinary skill will appreciate that other arrangements are possible without departing from the scope of the present disclosure.

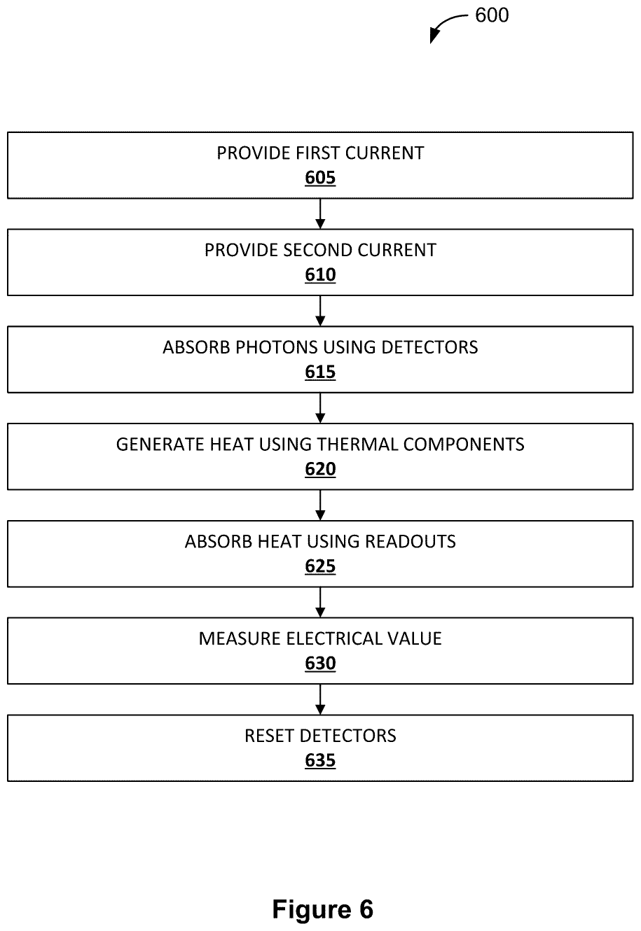

FIG. 6 is a flowchart of an example method 600, in accordance with some example embodiments. As shown in FIG. 6, process 600 may include providing, from a first electrical source, a first current that flows through a plurality of readout components, the plurality of readout components being electrically connected to a plurality of reset components, a readout component of the plurality of readout components having an first electrical resistance value (block 605). For example, a first electrical source may provide a first current that flows through a plurality of readout components, the plurality of readout components being electrically connected to a plurality of reset components, a readout component of the plurality of readout components having an first electrical resistance value, as described above. As also shown in FIG. 6, process 600 may include providing, from a second electrical source, a second current that flows through a plurality of detector components that are in a superconductive state, the plurality of detector components being electrically coupled to a plurality of thermal components (block 610). For example, a second electrical source may provide a second current that flows through a plurality of detector components that are in a superconductive state, the plurality of detector components being electrically coupled to a plurality of thermal components, as described above. As further shown in FIG. 6, process 600 may include absorbing one or more photons using the one or more of the plurality of detector components, the one or more of the plurality of detector components transitioning form the superconductive state to a non-superconductive state in response to absorbing the one or more photons, the one or more of the plurality of detector components having increased resistance due to the non-superconductive state such that a portion of the second current is directed to the plurality of thermal components (block 615). For example, the detection elements may absorb one or more photons, and the one or more of the plurality of detector components transitioning form the superconductive state to a non-superconductive state in response to absorbing the one or more photons, the one or more of the plurality of detector components having increased resistance due to the non-superconductive state such that a portion of the second current is directed to the plurality of thermal components, as described above. As also shown in FIG. 6, process 600 may include generating heat from the plurality of thermal components due to the portion of the second current (block 620). For example, the thermal component due to the portion of the second current, as described above. As further shown in FIG. 6, process 600 may include absorbing, by the plurality of readout components, the heat from the plurality of thermal components such that the plurality of readout components increase resistance from the first electrical resistance value to a second electrical resistance value that is higher than the first electrical resistance value, the plurality of reset components having a third electrical resistance value that is lower than the second electrical resistance value such that a portion of the first current is directed to the plurality of reset components (block 625). For example, the plurality of readout components may absorb the heat from the plurality of thermal components such that the plurality of readout components increase resistance from the first electrical resistance value to a second electrical resistance value that is higher than the first electrical resistance value, the plurality of reset components having a third electrical resistance value that is lower than the second electrical resistance value such that a portion of the first current is directed to the plurality of reset components, as described above. As also shown in FIG. 6, process 600 may include measuring an electrical value from the plurality of reset components to determine a quantity of the plurality of detector components that absorbed the one or more photons, the plurality of reset components being connected to an electrical ground such that the portion of the first current is removed by the electrical ground and the plurality of readout components are reset based on a time constant that depends at least in part of the third electrical resistance value of the plurality of reset components (block 630). For example, electrical control circuitry may measure an electrical value (e.g., voltage, current) from the plurality of reset components to determine a quantity of the plurality of detector components that absorbed the one or more photons, the plurality of reset components being connected to an electrical ground such that the portion of the first current is removed by the electrical ground and the plurality of readout components are reset based on a time constant that depends at least in part of the third electrical resistance value of the plurality of reset components, as described above.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

### EXAMPLE EMBODIMENTS

Example 1: A superconducting circuit, comprising: an optical waveguide; a plurality of superconducting photon detectors optically coupled to the optical waveguide; and a readout circuit thermally coupled to the plurality of superconducting photon detectors, the readout circuit comprising respective readout components for the plurality of superconducting photon detectors, each respective readout component having a corresponding reset component.

Example 2: The superconducting circuit of Example 1, wherein each corresponding reset component comprises a resistor.

Example 3: The superconducting circuit of Example 1 or Example 2, wherein a readout component of the respective readout components has first resistance value that transitions to a second resistance value in response a photon detection by a superconducting photon detector that corresponds to the readout component, wherein the second resistance value is higher than the first resistance value.

Example 4: The superconducting circuit of any one of Examples 1-3, wherein a reset component that corresponds to the readout component has a third resistance value that is lower than the second resistance value.

Example 5: The superconducting circuit of any one of Examples 1-4, wherein the third resistance value of the reset component is an order of magnitude smaller than the second resistance value of the readout component.

Example 6: The superconducting circuit of any one of Examples 1-5, wherein the second resistance value is one thousand ohms, and wherein the third resistance value is one hundred ohms.

Example 7: The superconducting circuit of any one of Examples 1-6, wherein a readout component of the respective readout components comprises a superconductor element.

Example 8: The superconducting circuit of any one of Examples 1-7, wherein the superconductor element is coupled in parallel with the corresponding reset component.

Example 9: The superconducting circuit of any one of Examples 1-8, wherein the readout circuit is electrically insulated from the plurality of superconducting photon detectors.

Example 10: The superconducting circuit of any one of Examples 1-9, wherein a superconducting photon detector of the plurality of superconducting photon detectors comprises a superconductor element thermally coupled to the readout circuit.

Example 11: The superconducting circuit of any one of Examples 1-10, further comprising a current source electrically coupled to the plurality of superconducting photon detectors.

Example 12: The superconducting circuit of any one of Examples 1-11, further comprising a current source electrically coupled to the readout circuit.

Example 13: The superconducting circuit of any one of Examples 1-12, wherein the plurality of superconducting photon detectors are arranged into a plurality of unit cells.

Example 14: The superconducting circuit of any one of Examples 1-13, wherein each unit cell of the plurality of unit cells includes a same number of superconducting photon detectors.

Example 15: The superconducting circuit of any one of Examples 1-14, wherein the readout circuit is configured to determine an amount of current flowing through a reset component.

Example 16: A method comprising: providing, from a first electrical source, a first current that flows through a plurality of readout components, the plurality of readout components being electrically connected to a plurality of reset components, a readout component of the plurality of readout components having an first electrical resistance value; providing, from a second electrical source, a second current that flows through a plurality of detector components that are in a superconductive state, the plurality of detector components being electrically coupled to a plurality of thermal components; absorbing one or more photons using the one or more of the plurality of detector components, the one or more of the plurality of detector components transitioning form the superconductive state to a non-superconductive state in response to absorbing the one or more photons, the one or more of the plurality of detector components having increased resistance due to the non-superconductive state such that a portion of the second current is directed to the plurality of thermal components; generating heat from the plurality of thermal components due to the portion of the second current; absorbing, by the plurality of readout components, the heat from the plurality of thermal components such that the plurality of readout components increase resistance from the first electrical resistance value to a second electrical resistance value that is higher than the first electrical resistance value, the plurality of reset components having a third electrical resistance value that is lower than the second electrical resistance value such that a portion of the first current is directed to the plurality of reset components; and measuring an electrical value from the plurality of reset components to determine a quantity of the plurality of detector components that absorbed the one or more photons, the plurality of reset components being connected to an electrical ground such that the portion of the first current is removed by the electrical ground and the plurality of readout components are reset based on a time constant that depends at least in part of the third electrical resistance value of the plurality of reset components.

Example 17: The method of Example 16, wherein the plurality of readout components are initially in a superconductive state, and wherein the heat transitions the plurality of readout components the non-superconductive state such that the plurality of readout components have the second electrical resistance value.

Example 18: The method of Example 16 or Example 17, wherein in the superconductive state the first electrical resistance value of the plurality of readout components is zero electrical resistance.

Example 19: The method of any one of Examples 16-18, wherein measuring the electrical value comprises measuring a voltage value of the plurality of reset components.

Example 20: The method of any one of Examples 16-19, wherein a reset component of the plurality of reset components comprises a resistive element.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

It will also be understood that, although the terms first, second, etc. are, in some instances, used herein to describe various elements, these elements should not be limited by these terms. These terms are only used to distinguish one element from another. For example, a first current could be termed a second current, and, similarly, a second current could be termed a first current, without departing from the scope of the various described embodiments. The first current and the second current are both currents, but they are not the same current unless explicitly stated as such.

As used herein, a “superconducting circuit” or “superconductor circuit” is a circuit having one or more superconducting materials. For example, a superconducting detector circuit is a detector circuit that includes one or more superconducting materials. As used herein, a “superconducting” material is a material that is capable of operating in a superconducting state (under particular conditions). For example, a material that operates as a superconductor (e.g., operates with zero electrical resistance) when cooled below a particular temperature (e.g., a critical temperature) and having less than a maximum current flowing through it. The superconducting materials may also operate in an “off” state where little or no current is present. In some embodiments, the superconducting materials operate in a non-superconducting state during which the materials have a non-zero electrical resistance (e.g., a resistance in the range of one thousand to ten thousand ohms). For example, a superconducting material supplied with a current greater than a threshold superconducting current for the superconducting material may transition from a superconducting state with zero electrical resistance to a non-superconducting state with non-zero electrical resistance.

As used herein, a “wire” is a section of material configured for transferring electrical current. In some embodiments, a wire includes a section of material conditionally capable of transferring electrical current (e.g., a wire made of a superconducting material that is capable of transferring electrical current while the wire is maintained at a temperature below a threshold temperature). A cross-section of a wire (e.g., a cross-section that is perpendicular to a length of the wire) optionally has a geometric (e.g., flat or round) shape or an irregular (also sometimes called a non-geometric) shape. In some embodiments, a length of a wire is greater than a width or a thickness of the wire (e.g., the length of a wire is at least 5, 6, 7, 8, 9, or 10 times greater than the width and the thickness of the wire).

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A superconducting circuit, comprising:
an optical waveguide;
a plurality of superconducting photon detectors optically coupled to the optical waveguide; and
a readout circuit thermally coupled to the plurality of superconducting photon detectors, the readout circuit comprising respective readout components for the plurality of superconducting photon detectors, each respective readout component having a corresponding reset component.

2. The superconducting circuit of claim 1, wherein each corresponding reset component comprises a resistor.

3. The superconducting circuit of claim 1, wherein a readout component of the respective readout components has first resistance value that transitions to a second resistance value in response a photon detection by a superconducting photon detector that corresponds to the readout component, wherein the second resistance value is higher than the first resistance value.

4. The superconducting circuit of claim 3, wherein a reset component that corresponds to the readout component has a third resistance value that is lower than the second resistance value.

5. The superconducting circuit of claim 4, wherein the third resistance value of the reset component is an order of magnitude smaller than the second resistance value of the readout component.

6. The superconducting circuit of claim 5, wherein the second resistance value is one thousand ohms, and wherein the third resistance value is one hundred ohms.

7. The superconducting circuit of claim 1, wherein a readout component of the respective readout components comprises a superconductor element.

8. The superconducting circuit of claim 7, wherein the superconductor element is coupled in parallel with the corresponding reset component.

9. The superconducting circuit of claim 1, wherein the readout circuit is electrically insulated from the plurality of superconducting photon detectors.

10. The superconducting circuit of claim 1, wherein a superconducting photon detector of the plurality of superconducting photon detectors comprises a superconductor element thermally coupled to the readout circuit.

11. The superconducting circuit of claim 1, further comprising a current source electrically coupled to the plurality of superconducting photon detectors.

12. The superconducting circuit of claim 1, further comprising a current source electrically coupled to the readout circuit.

13. The superconducting circuit of claim 1, wherein the plurality of superconducting photon detectors are arranged into a plurality of unit cells.

14. The superconducting circuit of claim 13, wherein each unit cell of the plurality of unit cells includes a same number of superconducting photon detectors.

15. The superconducting circuit of claim 1, wherein the readout circuit is configured to determine an amount of current flowing through a reset component.

16. A method comprising:
providing, from a first electrical source, a first current that flows through a plurality of readout components, the plurality of readout components being electrically connected to a plurality of reset components, a readout component of the plurality of readout components having an first electrical resistance value;
providing, from a second electrical source, a second current that flows through a plurality of detector components that are in a superconductive state, the plurality of detector components being electrically coupled to a plurality of thermal components;
absorbing one or more photons using the one or more of the plurality of detector components, the one or more of the plurality of detector components transitioning form the superconductive state to a non-superconductive state in response to absorbing the one or more photons, the one or more of the plurality of detector components having increased resistance due to the non-superconductive state such that a portion of the second current is directed to the plurality of thermal components;
generating heat from the plurality of thermal components due to the portion of the second current;
absorbing, by the plurality of readout components, the heat from the plurality of thermal components such that the plurality of readout components increase resistance from the first electrical resistance value to a second electrical resistance value that is higher than the first electrical resistance value, the plurality of reset components having a third electrical resistance value that is lower than the second electrical resistance value such that a portion of the first current is directed to the plurality of reset components; and
measuring an electrical value from the plurality of reset components to determine a quantity of the plurality of detector components that absorbed the one or more photons, the plurality of reset components being connected to an electrical ground such that the portion of the first current is removed by the electrical ground and the plurality of readout components are reset based on a time constant that depends at least in part of the third electrical resistance value of the plurality of reset components.

17. The method of claim 16, wherein the plurality of readout components are initially in a superconductive state, and wherein the heat transitions the plurality of readout components the non-superconductive state such that the plurality of readout components have the second electrical resistance value.

18. The method of claim 16, wherein in the superconductive state the first electrical resistance value of the plurality of readout components is zero electrical resistance.

19. The method of claim 16, wherein measuring the electrical value comprises measuring a voltage value of the plurality of reset components.

20. The method of claim 16, wherein a reset component of the plurality of reset components comprises a resistive element.
